(19) United States
(12) Patent Application Publication
(10) Pub. No.: US 2015/0234691 A1
(43) Pub. Date: Aug. 20, 2015

(54) METHOD AND A SYSTEM FOR SENDING A FIRST AND SECOND MESSAGE

(71) Applicant: BOOBERA LAGOON TECHNOLOGY LLC, Chicago, IL (US)

(72) Inventors: Matthew John Hurd, Belrose NSW (AU); Matthew John Fitzpatrick, Petersham NSW (AU)

(21) Appl. No.: 14/421,743

(22) PCT Filed: Aug. 14, 2013
(86) PCT No.: PCT/AU2013/000896

§ 371 Date: Feb. 13, 2015

(30) Foreign Application Priority Data
Aug. 14, 2012 (AU) 2012903484

(51) Int. Cl. G06F 9/54; G06F 1/14

(52) U.S. Cl. CPC G06F 9/546; G06F 1/14

(57) ABSTRACT

A system for sending a first message and a second message subsequent to the first message. The system comprises a message sender arranged to send the first message to a processor arranged to process the first message and the second message. The processor is arranged to refuse the second message until after the processor concludes transmitting a response to the first message. The message sender is further arranged to send the second message to the processor before receipt of the response to the first message and at a time for the second message to arrive at the processor after the processor concludes the sending of the response to the first message.

### TECHNICAL FIELD

The disclosure herein generally relates to a method and a system for sending first and second messages to a processor that may process one message at a time.

### BACKGROUND

Examples of services that may be provided by a networked processor include but are not limited to the trading of shares, derivatives and bonds, generally any type of financial instrument, commodities and futures, and gaming related services. Service may be initiated by a client sending an instruction in the form of an electronic message to the processor. The processor may extract the instruction from the message and subsequently execute the instruction. Some processors refuse a further message until a response to the electronic message has been sent by the processor, If the message is sent too soon it is refused. Consequently, the sending of the further message by the client may be triggered by receipt of the response to improve the rate at which instructions may be sent to the processor.

### SUMMARY

Disclosed herein is a method for sending a first message and a second message subsequent to the first message. The method comprises the step of sending the first message to a processor arranged to process the first message and the second message. The processor is arranged to refuse the second message until after the processor concludes transmitting a response to the first message. The method comprises the step of sending the second message to the processor before receipt of the response to the first message and at a time for the second message to arrive at the processor after the processor concludes sending the response to the first message.

The applicant's approach of sending the second message to arrive at the processor soon or immediately after the response to the first message has been sent may reduce the interval between the sending of the first and second messages by a client. The reduction in the interval may be by at least some of the time taken for the response to travel to the client, and at least some of the time taken for the second message to travel to the processor. The interval may be significantly reduced if the transmission times for the first and second message are relatively large, for example in that case that the client is a significant distance from the processor or the transmission rate is relatively low. Consequently, in the case that the processor is a trade matching engine, the client (who may be a broker or trader, for example), may be able to send through more orders in a given period than the client's competitors. In the case that the processor is a games server, the client (who may be a gamer) may be able to send through more gamming commands (for example, “shoot” or “dodge”) than the gamer's competitor. In these cases, a competitive advantage may result.

An embodiment comprises the step of determining the time. The step of determining the time may use processing interval information indicative of a predicted interval between the processor receiving the first message and the processor sending the response to the first message. The step of determining the time may comprise the step of adding the value of the predicted interval to a time at which the first message was sent.

In an embodiment, the step of determining the time may comprise the step of sending a plurality of irregularly spaced messages to the processor. The sending of the plurality of irregularly spaced messages may be to determine the processing interval information. Alternatively, the step of determining the time comprises statistically analyzing the processor's responses to another plurality of messages sent to the processor to determine the processing interval information.

In an embodiment, the second message is sent at a time for the second message to arrive at the processor a period after the processor concludes sending the response to the first message. There may be a degree of uncertainty of the interval between the processor receiving the first message and the processor sending the response to the first message. The interval may not be constant, and may be dependent on factors including but not limited to the type of the first message and the capacity of the processor. The period may allow for variations in the interval.

An embodiment comprises the step of determining the period to give a predetermined value to a probability of the arrival of the second message after the processor concludes sending the response to the first message. The chance of refusal of the second message may be controlled by varying the period to meet the client's requirements. A larger period may increase the chance that the second message will arrive after the response to the first message is sent. A shorter period may, however, reduce the period between the sending of the first and second message.

Disclosed herein is a computer program for instructing a processor, which when executed by the processor causes the processor to perform an embodiment of a method in accordance with the above disclosure.

Disclosed herein is processor readable tangible media including program instructions which when executed by a processor causes the processor to perform an embodiment of a method in accordance with the above disclosure.

Disclosed herein is a system for sending a first message and a second message subsequent to the first message. The system comprises a message sender arranged to send the first message to a processor arranged to process the first message and the second message. The processor is arranged to refuse the second message until after the processor concludes transmitting a response to the first message. The message sender is further arranged to send the second message to the processor before receipt of the response to the first message and at a time for the second message to arrive at the processor after the processor concludes the sending of the response to the first message.

An embodiment comprises a time determiner arranged to determine the time. The time determiner may be arranged to determine the time using processing interval information indicative of a predicted interval between the processor receiving the first message and the processor sending the response to the first message. The time determiner may be arranged to determine the time by adding the value of the predicted interval to a time at which the first message was sent. The time determiner may be arranged to determine the time by causing the message sender to send a plurality of irregularly spaced messages to the processor to determine the processing interval information. Alternatively, the time determiner is arranged to determine the time by statistically analyzing the processor's responses to another plurality of messages sent to the processor to determine the processing interval information.

An embodiment comprises memory in communication with the time determiner. The memory may hold information. The information may comprise the processing interval information. The time determiner may be arranged to put the information into the memory. The time determiner may he arranged to retrieve the information.

In an embodiment, the message sender is arranged to send the second message at a time for the second message to arrive at the processor a period after the processor concludes sending the response to the first message.

An embodiment comprises a period determiner arranged to determine the period to give a predetermined value to a probability of the arrival of the second message after the processor concludes sending the response to the first message.

It should be noted that any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows a schematic diagram of one embodiment of a system for sending a plurality of messages to a processor.

FIG. 2 shows a flow diagram of an embodiment of a method that may be performed by the system of FIG. 1.

FIG. 3 is a graphical representation of the interaction between the system and the processor.

FIG. 4 shows a schematic diagram of an example of a hardware architecture of the system of FIG. 1.

FIG. 5 shows a schematic diagram of another example of an architecture that the system of FIGS. 1 may have.

### DESCRIPTION OF EMBODIMENTS

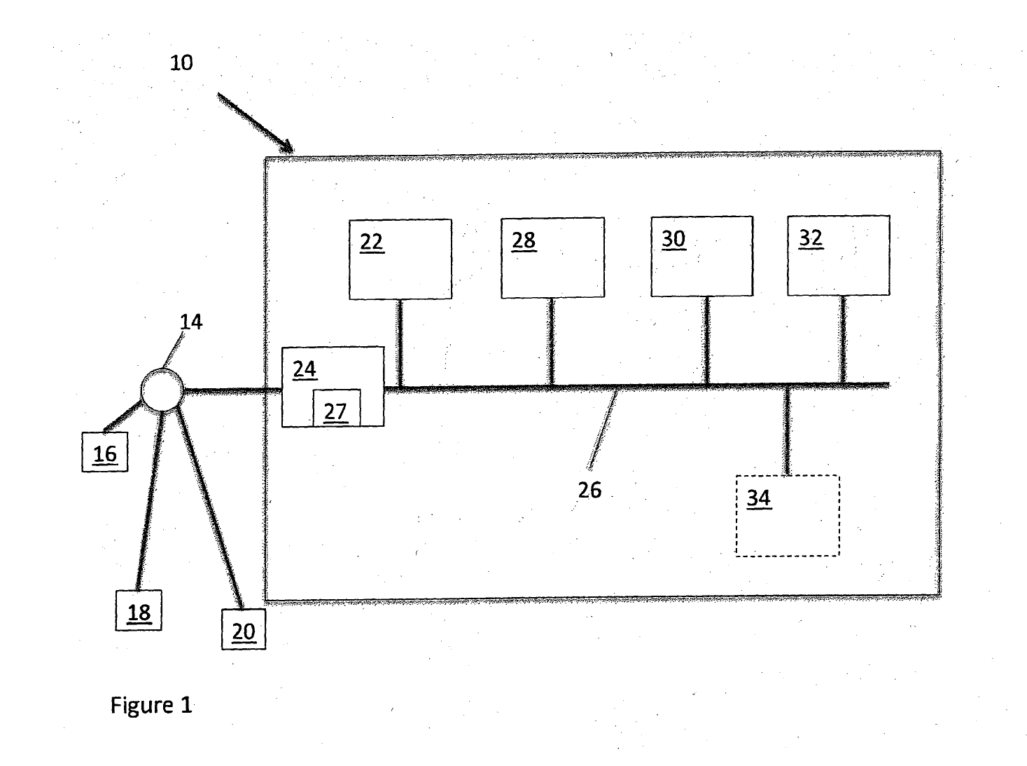

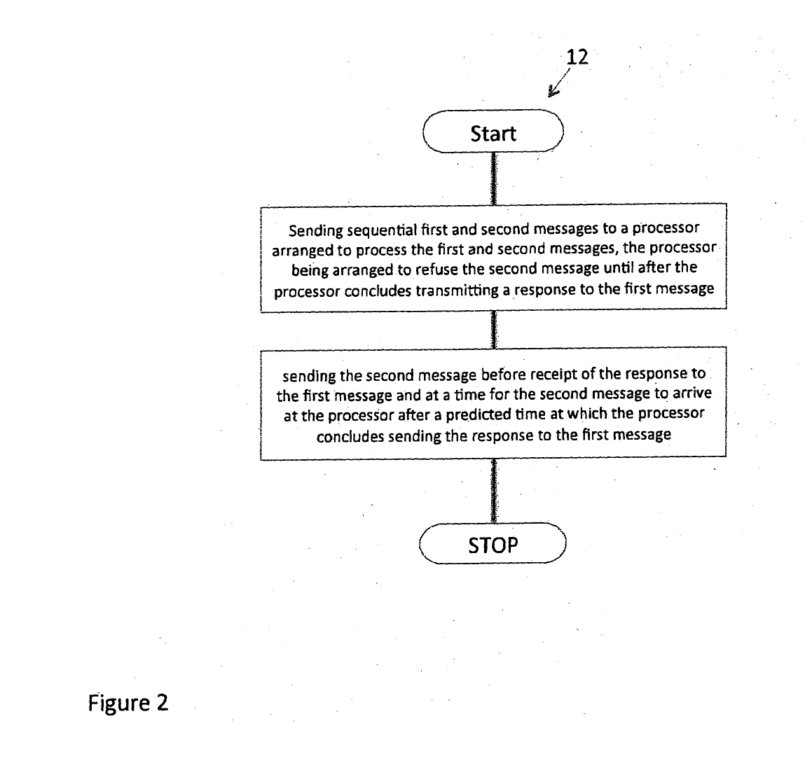

FIG. 1 shows a schematic diagram of one embodiment of a system for sending a plurality of messages, the system being generally indicated by the numeral 10. A broker or trader may control the system 10 which may be in the form of a computing system, for example. FIG. 2 shows a flow diagram of an embodiment of a method 12 that may be performed by the system 10. The system 10 is in communication with a network 14. The network may comprise at least one of an Ethernet network, an Infiniband network, and the Internet, for example, or any suitable networking technology. In an the system 10 has a point-to-point connection with the processor.

Also connected to the network 14 is a processor 16 that is arranged to receive the plurality of messages from the system 10 and optionally other messages from other optional systems 18,20. The other optional systems may be also in communication with the network 14, or may each have a point-to-point connection with the system 10. In this embodiment the processor 16 is in the form of a trade matching engine that performs services as instructed by the plurality of messages. The services include the matching of bids and offers for sale in relation to at least one of derivatives, securities, bonds and commodities. Accordingly, the plurality of messages may comprise, for example, any one of a sell order, a buy order or a cancel order. Alternatively the processor 16 may be, for example, a gaming server hosting a networked computer game.

Once the processor 14 receives a message it will refuse all subsequently received messages until after it has sent a response to the message. Refusal may include at least one of disabling a receiving transponder of the processor until after the response to the first message is sent, the system not acting on receipt of the second message, received by the system, and sending an error message to the system 10, for example. Generally, refusals may take any suitable form.

The system 10 has a plurality of modules 22, 24, 28, 30, and 32 in communication with each other over a bus 26. Module 22 is a message creator arranged to create messages in the form of at least one data packet or any other suitable form. The created messages may include buy, sell or cancel instructions in accordance with the directions of the system's controller, for example a broker or trader. The messages created by module 22 are communicated over the bus. 26 to a message sender 24 arranged to send over the network 14 (or point-to-point connections) the created messages to the processor 16. The system 10 has a message timer 27 that controls the timing of the sending of the messages by the message sender 24. In this embodiment, the message timer 27 is part of the message sender. In other embodiments, however, the message timer 27 may be a module 34 in communication with the message sender 24 via the bus 26. The message timer 27 may have any suitable arrangement with respect to the message sender 24.

The message sender 24 is also a response receiver for receiving responses to the plurality of messages sent to the processor.

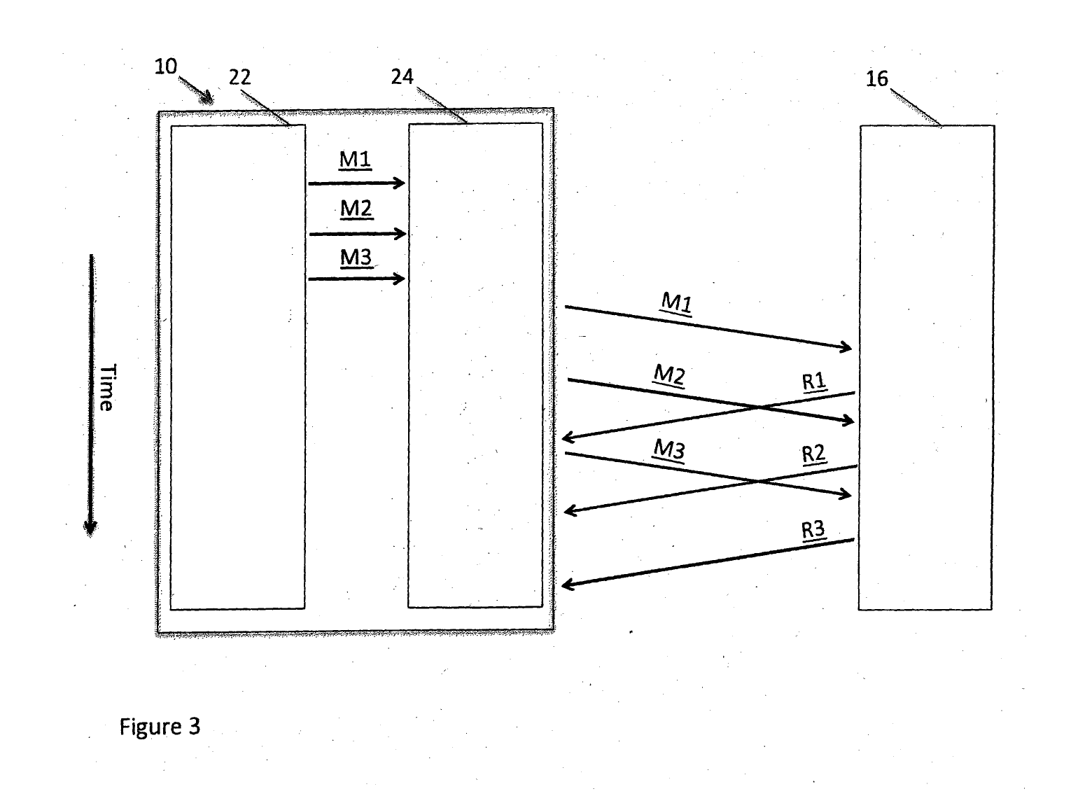

FIG. 3 is a graphical representation of an interaction between the system 10 and the processor 16, where time is increasing down the page. The message sender 24 receives a plurality of messages—indicated as M1, M2 and M3—from the message creator 22. The message sender 24 sends the first message M1 to the processor 16. The processor 16 receives M1. The message sender 24 then sends the second message M2 after sending the first message M1, the sending of the second message M2 being timed by message timer 27 for message M2 to arrive at the processor 16 after the processor 16 concludes the sending of the response R1 to the first message M1. As discussed above, the second message M2 will be refused if received by the processor in the interval between receipt of the first message M1 and transmission of the first response R1. There is a point in time where the message M2 is in transit to the processor 16 and the processor's response R1 to message M1 is in transit to the system 10. The crossing of the arrows representing M2 and R1 in FIG. 3 is indicative of the concurrent transit of M2 and R1. Concurrent transit gives less delay than sequential transit, allowing the plurality of messages to be sent more quickly.

While FIG. 3 shows that M1, M2 and M3 are sent as a group by message creator 22 to the message sender 24, and before any of M1, M2 and M3 are sent, the sending of the messages to the message sender may alternatively be interleaved with the sending of the messages from the message sender, for example. Generally, any suitable timing of the sending of messages may be used.

The system 10 has a time determiner 28. The time determiner 28 is arranged to determine the time at which a message should be sent in view of the preceding message. The time determiner receives information from the message timer to when a message is sent, and adds at least the predicted interval between the processor receiving a message and concludes the sending of a response to the message.

In the embodiment of FIG. 1, the system 10 interacts with the processor 16 to determine a representative interval that may be subsequently be used as the predicted interval. The interaction may be done at the beginning or during a session between the processor 16 and the system 10, for example. In embodiments where the processor 16 is a gaming server, for example, the interaction may comprise the time determiner 28 causing the message sender 24 to send a plurality of irregularly spaced messages to the processor 16. The messages may be ineffectual and/or innocuous, but they may not be. The plurality of irregularly spaced messages may be sent as a train of messages with a temporal spacing between the messages decreasing along the train. The processor 16 may respond to the plurality of irregularly spaced messages as they are received until one of the irregularly spaced messages has arrived before the sending of a response to the message preceding the one of the messages. The processor 16 does not respond to that message, or may send an error message to the system 10. In either case, the interval between the sending of the last two messages of the plurality of irregularly spaces apart messages accepted by the processor 16 may be indicative of, or near to, the interval between the processor receiving a message and concludes the sending of a response to the message. The value of the interval can be used for predicting the corresponding interval for later messages.

In another embodiment, the temporal spacing between the plurality of irregularly spaced messages may increase along the train. The spacing between the first message of the plurality of irregularly spaced messaged that is responded to and the second message of the plurality of irregularly spaced messages that is responded to is indicative of the minimum acceptable period between sequential messages.

In the embodiment of FIG. 1, for example, the system observes processor behavior over a sufficiently long enough period to generate the predicted interval. The system 10 may be arranged to generate predicted interval information indicative of the predicted interval by statistically analyzing the processors' responses to another plurality of messages sent to the processor. The other plurality of messages may or may not be sent by the system 10. Generally, but not necessarily, the other plurality of messages and the statistical analysis is performed prior to the sending of the plurality of messages. The statistical analysis may be performed by the time determiner 28, for example, or generally any suitable module.

An embodiment of the system is similar or identical to that of the embodiment of a system 10 of FIG. 1, except that the time determiner 28 causes the message sender 24 to send a plurality of irregularly spaced messages to the processor as described above.

The value of the interval may be stored by the time determiner 28 in memory 32. The memory is in communication with the time determiner 28. The time determiner 28 may add at least the value of the interval to the time that message M1 was sent to determine the time that message M2 should be sent, and so on. The time determiner 28 communicates the time so determined to the message timer 27 for timing the sending of the message M2 etc. More specifically, the value of the interval is added to the time that transmission of the first message M1 by the system 10 concluded, and the result is the earliest time that transmission of the second message M2 by the system 10 should commence.

The time determiner 28 may calculate the time to send messages without interacting with the processor. The memory has information for use by the time determiner 28 to determine the time. For example, the information may include the processing interval information. Consequently, the earliest time for sending the second message can be determined by adding the value of the processing interval to the time that the first message was sent.

It will be appreciated that different types of messages may have different processing intervals. The time determiner 28 may accommodate variations in processing intervals by sending to the system different message types. The processing intervals may be stored in memory and subsequently used for prediction.

The message sender 24 is arranged to send the second message at a time for the second message to arrive at the processor 16 a period after the processor 16 concludes sending the response to the first message. This may be done to accommodate a difference between an actual and a predicted message processing interval. The actual processing interval may be dependent on factors that may be unknown, such as the instant load on the processor, errors in the processor, or maintenance being performed on the processor which may reduce the processor's capacity: Similarly, the time taken for messages and responses to travel through the network 14 typically varies according to network load and random events such as the collision of packets at an intervening networking device such a switch, necessitating the resending of packets. The system has a period determiner 30 arranged to determine the period to give a predetermined value to a probability of the arrival of the second message after the processor concludes sending the response to the first message. This may generally be performed using a statistical analysis. For example, historical records of past messages and their responses may indicate that the minimum acceptable period between sequential messages is distributed around a mean of 10 microseconds, with a standard deviation of 1 microsecond. Consequently, the time determiner may space messages 13 microseconds apart (3 standard deviations from the mean), for example, so that the probability that the message is received after the response is sent is 99.73%. Of course, any suitable value, such as 1.1, 2.04 and 4.3 standard deviations may be used. The period determiner may communicate the length of the period to the time determiner 28 for use during determination of the time.

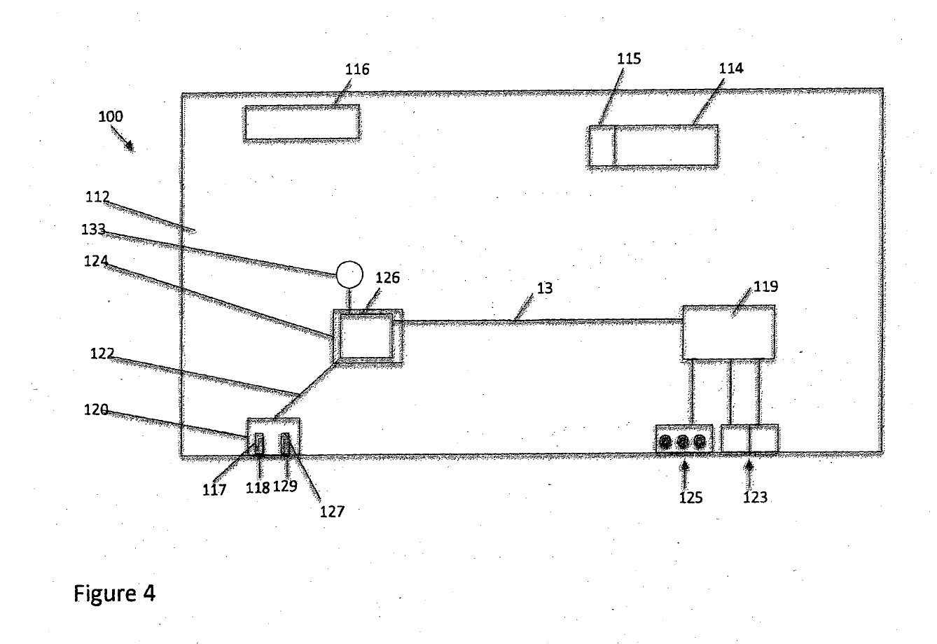

FIG. 4 shows a schematic diagram of an example of a hardware architecture 100 of the system 10 of FIG. 1. The architecture has a multilayer printed circuit board 112 having components mounted thereto which generally, but not necessarily, are connected to each other by conductive pathways, which may comprise, for example, tracks, signal traces, strip lines and/or micro strip lines, and wires, as appropriate. Generally, but not necessarily, the printed circuit board 112 is housed by a rack mountable enclosure having dimensions of 1 rack unit, although any suitable enclosure may be used or not used as desired. The printed circuit board has various surface mounted and/or through hole components mounted thereto.

A mains supply 114 may be mounted to the printed circuit board 112, the mains supply in use producing a relatively low voltage, such as 12, 24 or 48 volts as suitable, from a relatively high voltage source, for example, a 110V or 240V electricity grid. Alternatively, the rack may supply the relatively low voltage and the mains supply omitted. There may be a DC regulator in the form of a switched mode power supply module 115 mounted to the printed circuit board 112 that receives the low voltage output from the mains supply 114 and powers two or more active conductive rails integral to the circuit board 112. Alternatively, the mains supply and DC regulator may be mounted within the enclosure separate from the printed circuit board 112.

At least one fan 116 may be mounted to the circuit board 112 or alternatively the enclosure. The at least one fan may provide airflow across the multilayer printed circuit board to extract waste heat.

The printed circuit board 112 may also have mounted thereto a management unit 119 comprising, in this but not necessarily all embodiments, an ARM processor communicating with serial or Ethernet interfaces 123 for receiving instructions via an Ethernet (or other) management network or other source, for example. The management unit 119 may also control active indicia 125 in the form of LED status lights mounted at the front of the enclosure.

The architecture 100 has two ports 117 and 127, although other embodiments may have any number of ports. Each of the ports has a physical layer interface in the form of a transceiver, such as transceiver 118 of port 117. In this embodiment, but not necessarily in all embodiments, the plurality of transceivers comprise Small Form Factor Pluggable Plus (SFP+) transceivers. Other embodiments may use GBIC, XFP, XAUI transceivers, or generally any suitable transceivers. Alternative embodiments may use separate receivers and transmitters that are not integral to transceivers. The transceivers 118 are arranged to engage one or more received physical layer conduits in the form of external optical fibre network cables and/or copper network cables. The transceiver may send and receive electromagnetic communications in the form of at least one of an optical signal and an electrical signal. In this embodiment, the transceivers are each configured to receive two LC connectors terminating respective optical fibre cables that click into the transceiver, but any suitable connectors may be used. One of the optical fibers is for electromagnetic communications received by the transceiver, and communicates with a receiver of the transceiver, and the other is for electromagnetic communications sent by the transceiver and is connected to a transmitter of the transceiver. The transceivers generate electrical signals from the received optical signals, and subsequently communicate the electrical signals to the printed circuit board 12. The transceivers may support the gigabit Ethernet protocol and receive and/or transmit Ethernet packets, but other embodiments may have transceivers that support SONET, Fibre Channel, or any other suitable communications standard.

In this but not necessarily all architectures, one of the transceivers 129 in use receives a connector of an optical fibre network cable in communication with the network 14. Another one of the transceivers may be in communication with a personal computer, for example, which a trader or broker may generate orders with.

The transceivers may be housed in enclosures in the form of SFP cages 120 fixed to the printed circuit board 112. The cages provide an electrical connection between electrical contacts on the transceivers 118 and conductive tracks 122 in the form of stripline and/or micro stripline tracks formed on or within the circuit board 112. The cages may also act as Faraday cages to reduce electromagnetic interference, and extract heat from the transceiver. In alternative embodiments, the transceivers may be mounted directly to the printed circuit board.

The stripline 122 (which may be a micro-stripline, for example) provides a conduit for communications between the transceivers and a processor 124 comprising a logic device 126 in the form of a field programmable gate array (FPGA). In other embodiments, the logic device may be any Suitable logic device such as a complex programmable logic device, and an application-specific integrated circuit (ASIC). In some embodiments, the networking componentry may comprise more than one logic device.

The field programmable array 126 may have any suitable architecture. In one embodiment, the FPGA architecture comprises an array of configurable logic blocks, I/O pins, and routing channels. Generally but not necessarily, the logic blocks comprise of logical cells that may comprise of, for example, a look up table, a full adder, and a D-type flip flop. Clock signals may be routed through special purpose dedicated clock networks within the FPGA in communication with a reference clock 133 mounted on the printed circuit board 112. The reference clock 133 has a frequency of 156.25 MHz, but other frequencies may be used as appropriate. The FPGA may also include higher-level functionality including embedded multipliers, generic digital signal processing blocks, embedded processors, high-speed I/O logic for communication with components external of the FPGA (for example), and embedded memories that may be used by buffers.

The internal structure of the FPGA is configured to form a plurality of modules. The modules may have features of corresponding modules in FIG. 1, or the functions of those modules may be fragmented across more than one FPGA module. The FPGA modules are initially specified, for example, using a hardware description language, examples of which include HDL, VHDL and VERILOG. Code in C or some other language may be compiled or interpreted into the hardware description language. The functionality to be implemented in the FPGA is described in a hardware description language. The description is compiled, synthesized and mapped to the FPGA using appropriate EDA tools to a configuration file that, when loaded or programmed into the FPGA, causes the FPGA to implement the functionality described.

Generally, but not necessarily, the electromagnetic communications generated and/or processed by the system 10 comprise packets. The packets generally, but not necessarily, comprise, for example, a header, and a payload. The packets may also have a trailer. The electromagnetic communications may be structured in accordance with the Open Systems Interconnection Model or Internet Protocol Suite, in which each payload may be itself another packet of another layer of the OSI model. For example, at the physical layer the packet is a collection of bits. The physical layer packet may comprise a data link packet having a datalink header, a datalink payload and a datalink trailer. The datalink payload may in turn comprise a Network data packet such as an IP packet. The IP packet payload may comprise a TCP or UDP packet (“segment”). This layered structure may continue to the Application layer.

While the network connections described above may comprise optical and/or electrical Ethernet (10 Mb, 40 Mb, 1 Gb, 10 Gb, 40 Gb, 100 Gb, 400 Gb, 1 Tb), it will be understood that other network types and protocols may be used, such as INFINIBAND and WiFi. Generally, any packet based protocol may be used. Alternatively or additionally, one or more of the network connections may alternatively be a serial port connection, a USB port connection, a FireWire (TM) port connection, a ThunderBolt™ port connection, a PCI or PCIe connection, a SONET (or SDH) connection with or without a sonnet demultiplexing device, or generally any suitable type of connection.

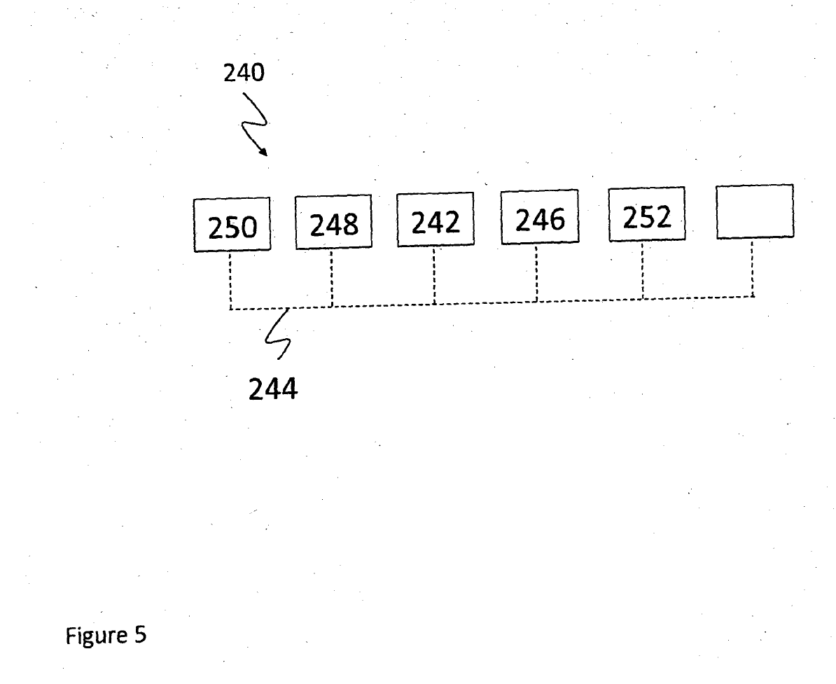

FIG. 5 shows a schematic diagram of another example of an architecture 240 that the system 10 of FIG. 1 may have. The method of FIG. 2, for example, may be coded in a program for instructing the processor. The program is, in this embodiment, stored in nonvolatile memory 248 in the form of a hard disk drive, but could be stored in FLASH, EPROM or any other form of tangible media within or external of the processor. The program generally, but not necessarily, comprises a plurality of software modules that cooperate when installed on the processor so that the steps of the method of FIG. 2 is performed. The software modules, at least in part, correspond to the steps of the method or components of the system or processors described above: The functions or components may be compartmentalized into modules or may be fragmented across several software modules. The software modules may be formed using any suitable language, examples of which include C++ and assembly. The program may take the form of an application program interface or any other suitable software structure. The processor 240 includes a suitable micro processor 242 such as, or similar to, the INTEL XEON or AMD OPTERON micro processor connected over a bus 244 to a random access memory 246 of around 1 GB and a non-volatile memory such as a hard disk drive 248 or solid state non-volatile memory having a capacity of around 1 Gb. Alternative logic devices may be used in place of the microprocessor 242. Examples of suitable alternative logic devices include application-specific integrated circuits, FPGAs, and digital signal processing units. The processor 240 has input/output interfaces 250 which may include one or more network interfaces, and a universal serial bus. The processor may support a human machine interface 252 e.g. mouse, keyboard, display etc.

Variations and/or modifications may be made to the embodiments described without departing from the spirit or ambit of the invention. For example, embodiments of the system have been disclosed in the context of a trading environment, however embodiments of the system may be applied to computer gaming, gambling, and auction environments. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A system for sending a first message and a second message subsequent to the first message, the system comprising:
a message sender arranged to send the first message to a processor arranged to process the first message and the second message, the processor being arranged to refuse the second message until after the processor concludes transmitting a response to the first message, the message sender being further arranged to send the second message to the processor before receipt of the response to the first message and at a time for the second message to arrive at the processor after the processor concludes the sending of the response to the first message.

2. A system defined by claim 1 comprising a time determiner arranged to determine the time.

3. A system defined by claim 2 wherein the time determiner is arranged to determine the time using processing interval information indicative of a predicted interval between the processor receiving the first message and the processor sending the response to the first message.

4. A system defined by claim 2 wherein the time determiner is arranged to determine the time by adding the value of the predicted interval to a time at which the first message was sent.

5. A system defined by claim 2 wherein the time determiner is arranged to determine the time by causing the message sender to send a plurality of irregularly spaced messages to the processor to determine the processing interval information.

6. A system defined by claim 2 wherein the time determiner is arranged to determine the time by statistically analyzing the processor's responses to another plurality of messages sent to the processor to determine the processing interval information.

7. A system defined by claim 2 comprising memory in communication with the time determiner, the memory holding information.

8. A system defined by claim 7 when dependent on claim 3 wherein the information comprises the processing interval information.

9. A system defined by claim 7 wherein the time determiner is arranged to put the information into the memory.

10. A system defined by claim 7 wherein the time determiner is arranged to retrieve the information.

11. A system defined by claim 1 wherein the message sender is arranged to send the second message at a time for the second message to arrive at the processor a period after the processor concludes sending the response to the first message.

12. A system defined by claim 11 comprising a period determiner arranged to determine the period to give a predetermined value to a probability of the arrival of the second message after the processor concludes sending the response to the first message.

13. A method for sending a first message and a second message subsequent to the first message, the method comprising the steps of
sending the first message to a processor arranged to process the first message and the second message, the processor being arranged to refuse the second message until after the processor concludes transmitting a response to the first message; and
sending the second message to the processor before receipt of the response to the first message and at a time for the second message to arrive at the processor after the processor concludes sending the response to the first message.

14. A method defined by claim 13 comprising the step of determining the time.

15. A method defined by claim 14 wherein the step of determining the time uses processing interval information indicative of a predicted interval between the processor receiving the first message and the processor sending the response to the first message.

16. A method defined by claim 14 wherein the step of determining the time comprises the step of adding the value of the predicted interval to the time at which the first message was sent.

17. A method defined by claim 14 wherein the step of determining the time comprises the step of sending a plurality of irregularly spaced messages to the processor.

18. A method defined by claim 14 comprising determining the time by statistically analyzing the processor's responses to another plurality of messages sent to the processor to determine the processing interval information.

19. A method defined by claim 13 wherein the second message is sent at a time for the second message to arrive at the processor a period after the processor concludes sending the response to the first message.

20. A method defined by claim 19 comprising the step of determining the period to give a predetermined value to a probability of the arrival of the second message after the processor concludes sending the response to the first message.

21. (canceled)

22. A processor readable tangible media including program instructions which when executed by a processor causes the processor to perform a method defined by claim 13.
